(19) United States
(12) Patent Application Publication
(10) Pub. No.: US 2020/0215410 A1
(43) Pub. Date: Jul. 9, 2020

(54) ALIGNING SENSOR DATA WITH VIDEO

(71) Applicant: Intel Corporation, Santa Clara, CA (US)

(72) Inventors: Wenlong Li, Beijing (CN); Xiaofeng Tong, Beijing (CN); Qiang Li, Beijing (CN); Nadia P. Banks, Santa Clara, CA (US); Doron T. Houminer, Harutzim (IL)

(73) Assignee: Intel Corporation, Santa Clara, CA (US)

(21) Appl. No.: 16/080,947

(22) PCT Filed: Sep. 29, 2017
(86) PCT No.: PCT/CN2017/104417

§ 371 Date: Aug. 29, 2018

(51) Int. Cl. A63B 71/06; A63B 24/00; G06T 7/20; G06K 9/00; G06T 7/70

(52) U.S. Cl. CPC A63B 71/06; A63B 24/0021; G06T 7/20; G06K 9/00711; G06T 7/70; A63B 2102/18; A63B 2024/0025; A63B 2220/806; A63B 2220/836; A63B 2243/0037; G06K 9/00362

(57) ABSTRACT

An embodiment of a semiconductor package apparatus may include technology to recognize an action in a video, determine a synchronization point in the video based on the recognized action, and align sensor-related information with the video based on the synchronization point. Other embodiments are disclosed and claimed.

### TECHNICAL FIELD

Embodiments generally relate to video systems. More particularly, embodiments relate to aligning sensor data with video.

### BACKGROUND

Some entertainment and/or analytic applications may attempt to combine video information with sensor information, with varying degrees of success.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of an electronic processing system according to an embodiment;

FIG. 2 is a block diagram of an example of a semiconductor package apparatus according to an embodiment;

FIGS. 3A to 3C are flowcharts of an example of a method of aligning sensor-related information according to an embodiment;

FIG. 4 is a block diagram of an example of sensor alignment apparatus according to an embodiment:

FIG. 5 is an illustrative diagram of examples of action poses during a swing according to an embodiment;

FIG. 6 is a flowchart of another example of a method of aligning sensor-related information according to an embodiment;

FIG. 7 is an illustrative diagram of an example of a display of a sports application according to an embodiment;

FIG. 8 is an illustrative diagram of an example of an overlay application on a display of a live sports video according to an embodiment;

FIG. 9 is a flowchart of another example of a method of aligning sensor-related information according to an embodiment:

FIG. 10 is an illustrative diagram of another example of an overlay application on a display of a live sports video according to an embodiment;

FIG. 11 is a block diagram of an example of a system having a navigation controller according to an embodiment; and

FIG. 12 is a block diagram of an example of a system having a small form factor according to an embodiment.

### DESCRIPTION OF EMBODIMENTS

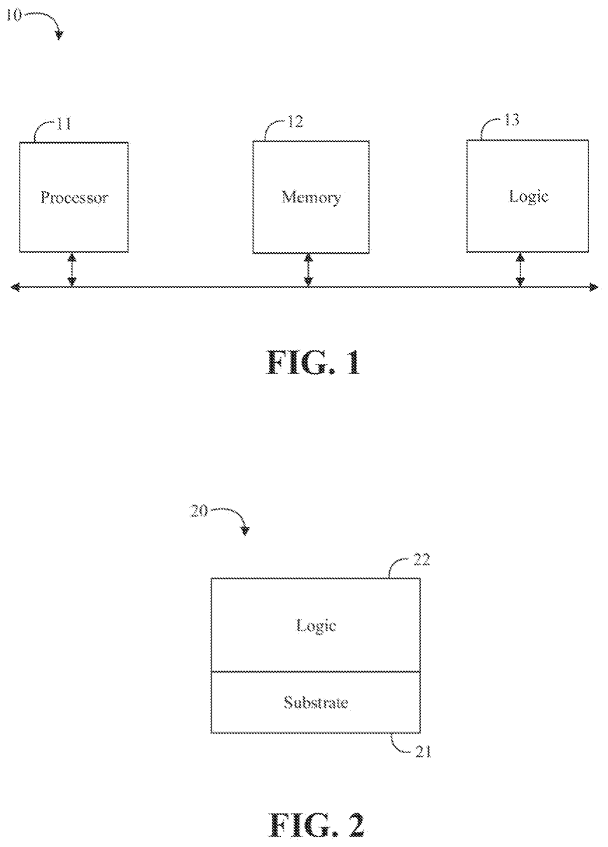

Turning now to FIG. 1, an embodiment of an electronic processing system 10 may include a processor 11, memory 12 communicatively coupled to the processor 11, and logic 13 communicatively coupled to the processor 11 to recognize an action in a video, determine a synchronization point in the video based on the recognized action, and align sensor-related information with the video based on the synchronization point. In some embodiments, the logic 13 may be further configured to determine the synchronization point based on computer vision (e.g., using computer vision technology). For example, the logic 13 may also be configured to recognize a participant in the video, track a location of the participant in the video, and map the sensor-related information to the tracked location of the participant in the video. In some embodiments, the logic 13 may be further configured to identify two or more participants in the video, associate each participant with a sensor worn by the participant, and overlay sensor-related information corresponding to the associated participant in the video. For example, the logic 13 may also be configured to estimate a pose of the participant to recognize a start of an action, and/or to select a participant to track based on an input from a user. In some embodiments, manually labeled data may also be overlaid based on the recognized action, the sensor-related information, the identified/selected player, and/or the tracking information. Some embodiments may advantageously align the sensor space to the video/screen space.

Embodiments of each of the above processor 11, memory 12, logic 13, and other system components may be implemented in hardware, software, or any suitable combination thereof. For example, hardware implementations may include configurable logic such as, for example, programmable logic arrays (PLAs), field programmable gate arrays (FPGAs), complex programmable logic devices (CPLDs), or fixed-functionality logic hardware using circuit technology such as, for example, application specific integrated circuit (ASIC), complementary metal oxide semiconductor (CMOS) or transistor-transistor logic (TTL) technology, or any combination thereof.

Alternatively, or additionally, all or portions of these components may be implemented in one or more modules as a set of logic instructions stored in a machine- or computer-readable storage medium such as random access memory (RAM), read only memory (ROM), programmable ROM (PROM), firmware, flash memory, etc., to be executed by a processor or computing device. For example, computer program code to carry out the operations of the components may be written in any combination of one or more operating system (OS) applicable/appropriate programming languages, including an object-oriented programming language such as PYTHON, PERL, JAVA, SMALLTALK, C++, C# or the like and conventional procedural programming languages, such as the “C” programming language or similar programming languages. For example, the memory 12, persistent storage media, or other system memory may store a set of instructions which when executed by the processor 11 cause the system 10 to implement one or more components, features, or aspects of the system 10 (e.g., the logic 13, recognizing an action in a video, determining a synchronization point in the video based on the recognized action, aligning sensor-related information with the video based on the synchronization point, etc.).

Turning now to FIG. 2, an embodiment of a semiconductor package apparatus 20 may include a substrate 21, and logic 22 coupled to the substrate 21, where the logic 22 is at least partly implemented in one or more of configurable logic and fixed-functionality hardware logic. The logic 22 coupled to the substrate 21 may be configured to recognize an action in a video, determine a synchronization point in the video based on the recognized action, and align sensor-related information with the video based on the synchronization point. In some embodiments, the logic 22 may be further configured to determine the synchronization point based on computer vision (e.g., using computer vision technology). For example, the logic 22 may also be configured to recognize a participant in the video, track a location of the participant in the video, and map the sensor-related information to the tracked location of the participant in the video. In some embodiments, the logic 22 may be further configured to identify two or more participants in the video, associate each participant with a sensor worn by the participant, and overlay sensor-related information corresponding to the associated participant in the video. For example, the logic 22 may also be configured to estimate a pose of the participant to recognize a start of an action, and/or to select a participant to track based on an input from a user.

Embodiments of logic 22, and other components of the apparatus 20, may be implemented in hardware, software, or any combination thereof including at least a partial implementation in hardware. For example, hardware implementations may include configurable logic such as, for example, PLAs, FPGAs, CPLDs, or fixed-functionality logic hardware using circuit technology such as, for example. ASIC, CMOS, or TTL technology, or any combination thereof. Additionally, portions of these components may be implemented in one or more modules as a set of logic instructions stored in a machine- or computer-readable storage medium such as RAM, ROM, PROM, firmware, flash memory, etc., to be executed by a processor or to computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

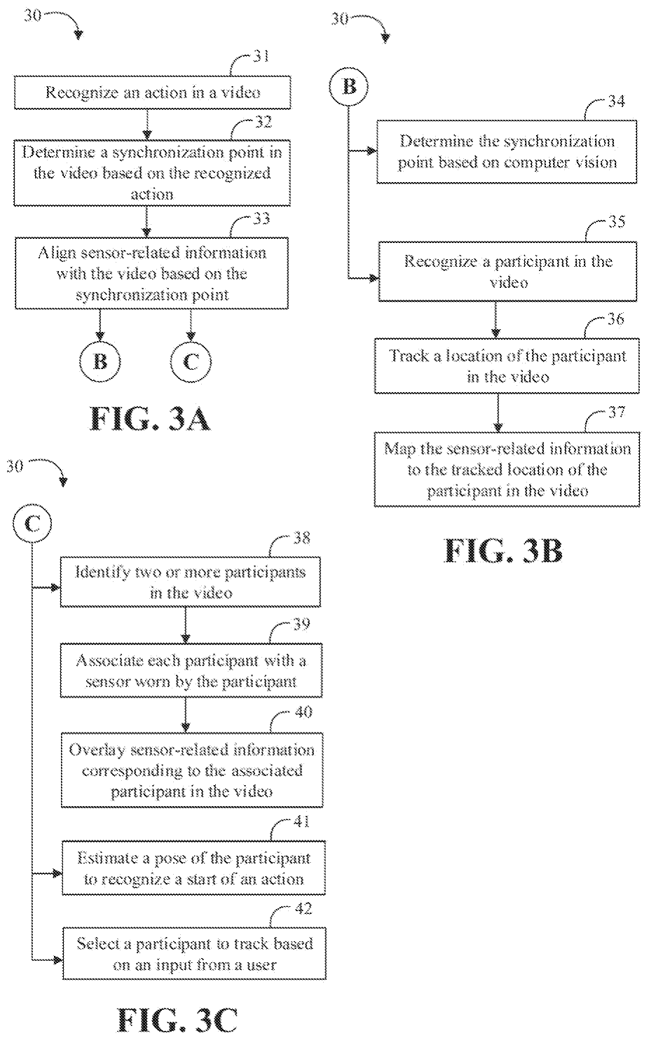

Turning now to FIG. 3, an embodiment of a method 30 of aligning sensor-related information may include recognizing an action in a video at block 31, determining a synchronization point in the video based on the recognized action at block 32, and aligning sensor-related information with the video based on the synchronization point at block 33. Some embodiments of the method 30 may further include determining the synchronization point based on computer vision at block 34 (e.g., using computer vision technology). For example, the method 30 may also include recognizing a participant in the video at block 35, tracking a location of the participant in the video at block 36, and mapping the sensor-related information to the tracked location of the participant in the video at block 37. Some embodiments of the method 30 may further include identifying two or more participants in the video at block 38, associating each participant with a sensor worn by the participant at block 39, and overlaying sensor-related information corresponding to the associated participant in the video at block 40. For example, the method 30 may also include estimating a pose of the participant to recognize a start of an action at block 41, and/or selecting a participant to track based on an input from a user at block 42.

Embodiments of the method 30 may be implemented in a system, apparatus, computer, device, etc., for example, such as those described herein. More particularly, hardware implementations of the method 30 may include configurable logic such as, for example. PLAs, FPGAs, CPLDs, or in fixed-functionality logic hardware using circuit technology such as, for example. ASIC, CMOS, or TTL technology, or any combination thereof. Alternatively, or additionally, the method 30 may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++. C# or the like and conventional procedural programming languages, such as the “C” programming language or similar programming languages.

For example, the method 30 may be implemented on a computer readable medium as described in connection with Claims 19 to 24 below. Embodiments or portions of the method 30 may be implemented in firmware, applications (e.g., through an application programming interface (API)), or driver software running on an operating system (OS).

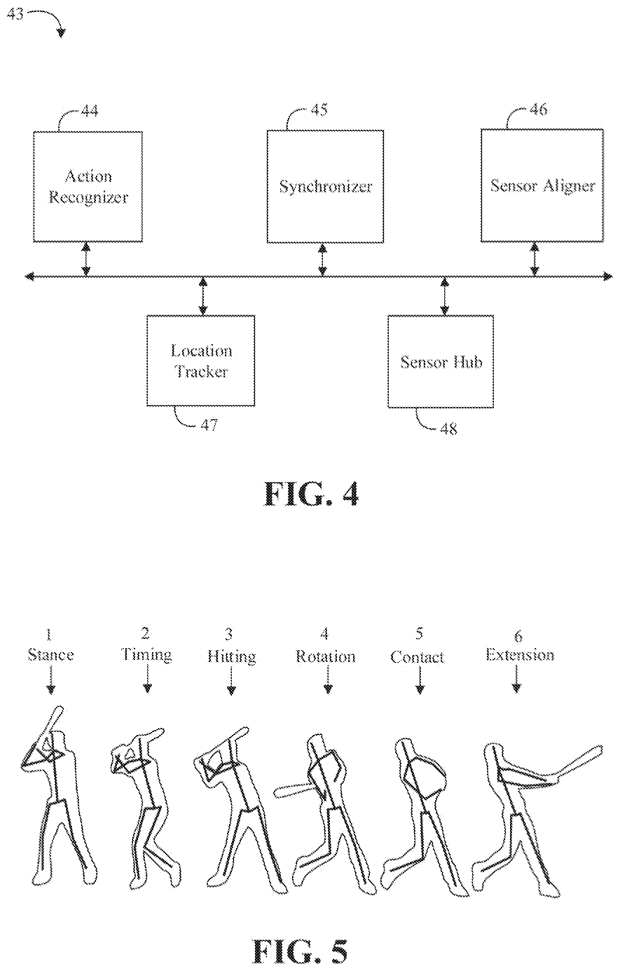

Turning now to FIG. 4, an embodiment of a sensor alignment apparatus 43 may include an action recognizer 44, a synchronizer 45, a sensor aligner 46, a location tracker 47, and/or a sensor hub 48. The action recognizer 44 may be configured to recognize an action in a video. The synchronizer 45 may be configured to determine a synchronization point in the video based on the recognized action. The sensor aligner 46 may be configured to align sensor-related information with the video based on the synchronization point. In some embodiments, the synchronizer 45 may be further configured to determine the synchronization point based on computer vision (e.g., using computer vision technology). For example, the action recognizer 44 may also be configured to recognize a participant in the video, the location tracker 47 may be configured to track a location of the participant in the video, and the sensor aligner 46 may be configured to map the sensor-related information to the tracked location of the participant in the video. In some embodiments, the action recognizer 44 may be further configured to identify two or more participants in the video, the synchronizer 45 may be configured to associate each participant with a sensor worn by the participant, and the sensor aligner 46 may be configured to overlay sensor-related information corresponding to the associated participant in the video. For example, the action recognizer 44 may also be configured to estimate a pose of the participant to recognize a start of an action, and/or the location tracker 47 may be configured to select a participant to track based on an input from a user.

Sense Engine Examples

In accordance with some embodiments, a sense engine may get information from sensors, content, services, and/or other sources to provide sensed information. The sensed information may include, for example, image information, audio information, motion information, depth information, temperature information, biometric information. CPU information. GPU information, etc. At a high level, some embodiments may use sensed information to determine sensor-related information for the sensor/video alignment system.

For example, a sense engine may include a sensor hub communicatively coupled to two dimensional (2D) cameras, three dimensional (3D) cameras, depth cameras, gyroscopes, accelerometers, inertial measurement units (IMUs), first and second order motion meters, location services, microphones, proximity sensors, thermometers, biometric sensors, etc., and/or a combination of multiple sources which provide information to the action recognizer, the synchronizer, the sensor aligner, the location tracker, etc. The sensor hub may be distributed across multiple devices. The information from the sensor hub may include or be combined with input data from user and/or participant devices (e.g., smartphones, wearables, sports equipment, etc.).

For example, the user/participant device(s) may include one or more 2D, 3D, and/or depth cameras. The user/participant device(s) may also include gyroscopes, accelerometers, IMUs, location services, thermometers, biometric sensors, etc. For example, the user and/or participant(s) may carry a smartphone (e.g. in their pocket), may wear a wearable device (e.g. such as a smart watch, an activity monitor, a fitness tracker, and/or an activity specific device), and/or may utilize sports equipment (e.g., balls, bats, racquets, etc.) which may include one or more sensors. The user/participant device(s) may also include a microphone which may be utilized to detect if the user/participant is speaking, making non-speech sounds, speaking to another nearby person, etc. The sensor hub may include some or all of the user/participant(s)' various devices which are capable of capturing information related to the user/participant(s)' actions or activity (e.g. including an input/output (I/O) interface of the devices which can capture keyboard/mouse/touch activity). The sensor hub may get information directly from the capture components of the devices (e.g. wired or wirelessly) or the sensor hub may be able to integrate information from the devices from a server or a service (e.g. information may be uploaded from a fitness tracker to a cloud service, which the sensor hub may download).

Computer Vision and Action Recognizer/Classifier

In accordance with some embodiments, the system may include and/or implement a sensor/video alignment system utilizing a sensor hub, machine vision, and/or machine learning to align sensor space with video/screen space. Some sensor/video information may be determined by image processing or machine vision processing the content. Some embodiments of a machine vision system, for example, may analyze and/or perform feature/object recognition on images captured by a camera. For example, machine vision and/or image processing may identify and/or recognize participants or objects in a scene (e.g., a person, an animal, a bat, a club, a ball, etc.). The machine vision system may also be configured to perform facial recognition, gaze tracking, facial expression recognition, action recognition, action classification, pose recognition, and/or gesture recognition including body-level gestures, arm/leg-level gestures, hand-level gestures, and/or finger-level gestures. The machine vision system may be configured to classify an action of the user. In some embodiments, a suitably configured machine vision system may be able to determine if the user is sitting, standing, running, hitting, shooting, and/or otherwise taking some other action or activity. For example, video and/or images may be machine-analyzed (e.g., using a machine learning system, either locally or in the cloud) to determine a participant action.

Embodiments of the action recognizer 44, the synchronizer 45, the sensor aligner 46, location tracker 47, the sensor hub 48, and other components of the sensor alignment apparatus 43, may be implemented in hardware, software, or any combination thereof including at least a partial implementation in hardware. For example, hardware implementations may include configurable logic such as, for example, PLAs, FPGAs, CPLDs, or fixed-functionality logic hardware using circuit technology such as, for example, ASIC, CMOS, or TTL technology, or any combination thereof. Additionally, portions of these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA. SMALLTALK. C++, C# or the like and conventional procedural programming languages, such as the “C” programming language or similar programming languages.

Some embodiments may advantageously provide a method and/or apparatus for aligning sensor data with video (e.g., in sports as an example application). In sports, employing a sensor may help improve analysis and/or performance. For example, MOTUS and ZEPP may attach sensors (e.g., accelerator and gyro) to the bat to capture a baseball swing motion including speed, orientation, time to contact, etc. SHOTTRACKER may benefit from a basketball player wearing a SHOTTRACKER sensor to track the player's performance in terms of shot, distance, location, etc. Meanwhile, video may be widely used for broadcasting and coaching purposes. For example, DARTFISH may record video and let a coach annotate the video manually to instruct players where to improve. Because video offers visual information and the sensor gives accurate motion metrics, there may be a strong demand to combine both in some embodiments to offer a compelling experience such that a player can review their performance with an accurate metric overlaid on top of the replayed video immediately after the performance. However, some other systems can't address this requirement because the system doesn't have access to both the sensor and video information, and/or there is no effective global synchronization mechanism to align both sensor and video data (e.g., and/or the attempted synchronization may be made more effective). Some embodiments may advantageously align sensor-related information with video information. Some embodiments may advantageously provide both the sensor and video data to improve accessibility to both sets of data. Some embodiments may improve analysis, performance, help a player play better and/or help a team win more.

Though some embodiments herein use baseball and basketball for explanation, embodiments may also be applicable to other sports (e.g., soccer, American football, tennis, etc.) and to non-sports applications (e.g., shipping, warehouse logistics, food preparation, etc.). In some embodiments, the participants may be people. In some embodiments, the participants may be animals (e.g., horse racing, dog racing, etc.). In some embodiments, the participants may be objects (e.g., car racing, boat racing, sailing competitions, robot competitions, etc.).

Some embodiments may employ action recognition technology to determine the synchronization point of motion captured in the video and use that synchronization point to align the sensor data with visual motion. For example, an aspect of sensor alignment in accordance with some embodiments may correspond to when to overlay sensor-related information on a screen showing the video. Aligning the sensor motion data with the corresponding motion in the video at the same time the motion is occurring (e.g., as determined by image processing and/or computer vision action recognition) may provide a better user experience. Some embodiments may also use player recognition technology and tracking technology to locate every player on the field, and then employ the location as the synchronization to map the sensor to the player in the video. For example, another aspect of sensor alignment in accordance with some embodiments may correspond to where to overlay sensor-related information on a screen showing the video. Aligning the sensor-related information with the corresponding location in the video (e.g., as determined by image processing and/or computer vision action recognition) may provide a better user experience. Sensor-related information may include direct sensor measurements or may include information derived from, calculated from, or otherwise based on the sensor measurements. For example, sensor measurements from an accelerometer may be used to calculate angular velocity and/or linear velocity. Further calculations based on the length of a club, bat, racquet, etc., and/or where along that length the ball was struck may be used to determine those velocities at the point of contact.

Other systems may overlay information on top of video without the consideration of synchronization. For example, a ZEPP system may capture swing motion metrics via sensor, record swing video with camera. The ZEPP system then puts the statistics on top of the video without checking where the swing motion is in the video. That is, the swing motion data may show up before the swing happens in the video, and this causes a lot of complaints as there is no synchronization. Some embodiments may advantageously provide a better user experience by aligning the sensor-related information with the video including, for example, when the sensor-related data is overlaid on the video and/or where the data is positioned on the video.

For team sports like basketball, some other systems overlay team or player(s)' statistics on top of video with no correlation to any specific team member. Some embodiments may advantageously recognize the action begin and end in the video, and then connect the sensor-related data to the corresponding motion in the video. Furthermore, some embodiments may identify every player in the team sport, associate each player with the sensor they wear, and may then can extract sensor-related data and overlay it on the corresponding player in the video (e.g., near the player's position in the video, but avoiding placement of the data where it would obstruct the image of the player).

To align sensor data with video, some embodiments may determine the synchronization point between the sensor-related information and the video information. Some embodiments may include a global timer to attach the time to every recorded event. However, synchronizing to a central timer may not be battery friendly for wearable device. In addition, streaming data from a wearable device to mobile devices may experience uncertain delay, which may make it more difficult to infer when sensor data may be available. Accordingly, using a centralized timer may not be feasible or as effective for some embodiments. Some embodiments may advantageously use computer vision technology to determine the synchronization point. For swing motion sports like baseball, golf, tennis, etc., some embodiments may utilize action recognition technology to determine the start point of motion in video. For ball sports like basketball, soccer, American football, etc., some embodiments may utilize recognition and tracking technology to locate the player and then extract corresponding sensor-related information for overlaying.

FIG. 5 shows one example of a baseball batting motion, where a swing may be divided into six stages including (1) a stance stage, (2) a timing stage, (3) a hitting stage, (4) a rotation stage, (5) a contact stage, and (6) an extension stage. To determine the swing motion start point, some embodiments may first apply person detection to determine the body position of the baseball player, and then use action recognition to locate the start of swing motion as shown in the stance stage. Some embodiments may also use human pose estimation to compare the body joint position and orientation with ground truth to determine the batting swing start (e.g., FIG. 5 shows the human joints per a human pose estimation technique as heavier lines inside the outline of the baseball player).

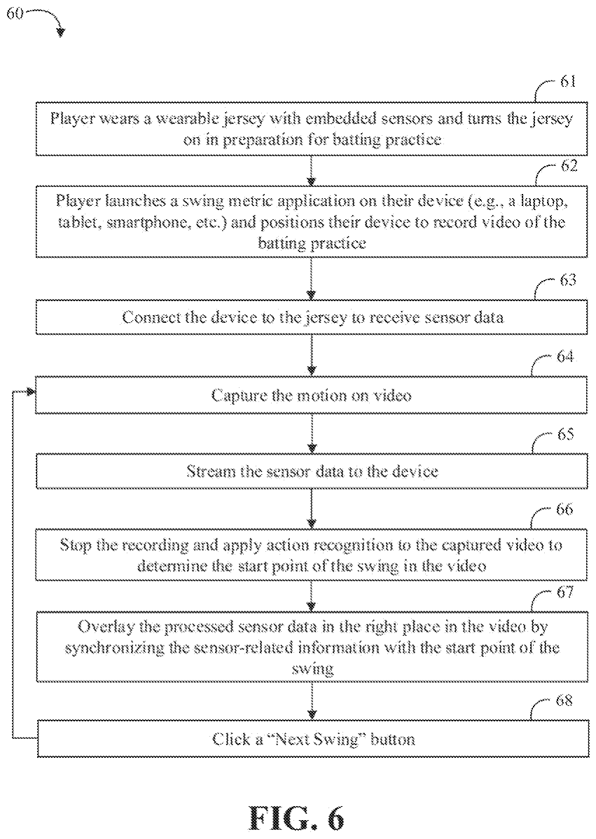

Turning now to FIG. 6, an embodiment of a method 60 of how to align sensor data with the swing motion captured in a video in a swing metric application may include a player wearing a wearable jersey with embedded sensors and turning the jersey on in preparation for batting practice at block 61. The method 60 may also include the player launching a swing metric application on their device (e.g., a laptop, tablet, smartphone, etc.) and positioning their device to record video of the batting practice at block 62 (e.g., the video recording may be enabled automatically to capture the swing when the application is launched). The method 60 may then include connecting the swing metric application to the jersey to receive sensor data at block 63 (e.g., wirelessly via WIFI, BLUETOOTH, etc.). When the player makes a swing motion, the method 60 may include capturing the motion on video at block 64, and streaming the sensor data to the device at block 65. The method 60 may then include stopping the recording and applying action recognition to the captured video to determine the start point of the swing in the video at block 66. The method 60 may then include overlaying the processed sensor data in the right place in the video by synchronizing the sensor-related information with the start point of the swing as determined by the applied action recognition at block 67. The user may then click a “Next Swing” button or otherwise indicate a restart to the swing metric application at block 68 to resume the method at block 64. In some embodiments, all of the method 60 may be performed locally on the user's device, while in other embodiments portions of the method 60 may be performed by a connected cloud service.

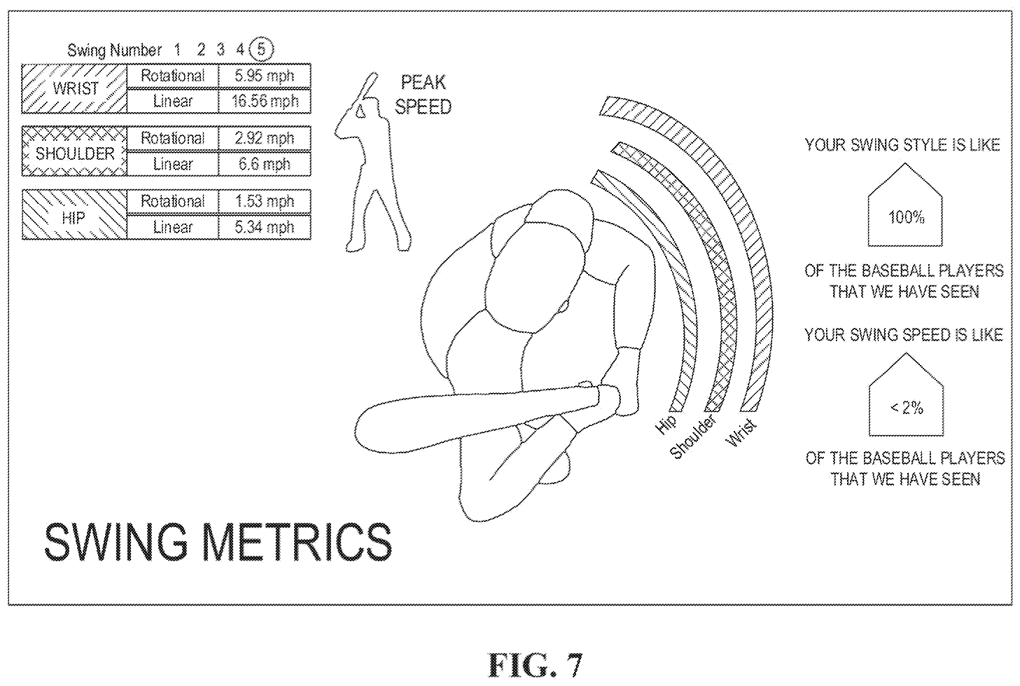

FIG. 7 shows an illustrative embodiment of a swing metric application, where a number of metrics may be derived from the sensors in the wrist, shoulder, and hip of a wearable jersey. To facilitate video coaching, some embodiments may record video in parallel with the sensor based motion capture, where video may be used to analyze the swing pose or other characteristics of the swing. The overhead perspective of the player and/or the other view of the player may originate from video captured at the time of the swing. Additionally, one of the images of the player may originate from captured video while the other of the image of the player may be computer generated graphics (e.g., simulated from the captured video information and/or the captured sensor information). Advantageously, some embodiments may determine the start point of the swing in the captured video (e.g., using action recognition, computer vision, etc.) and synchronize the overlay of the sensor-related information with the start point of the swing in the captured video. Other points in the swing (e.g., corresponding with the stages in FIG. 5) may also be synchronized with the overlay of different sensor-related information. For example, the swing metric application may pause at different swing stages and overlay the appropriate sensor-related information for each stage.

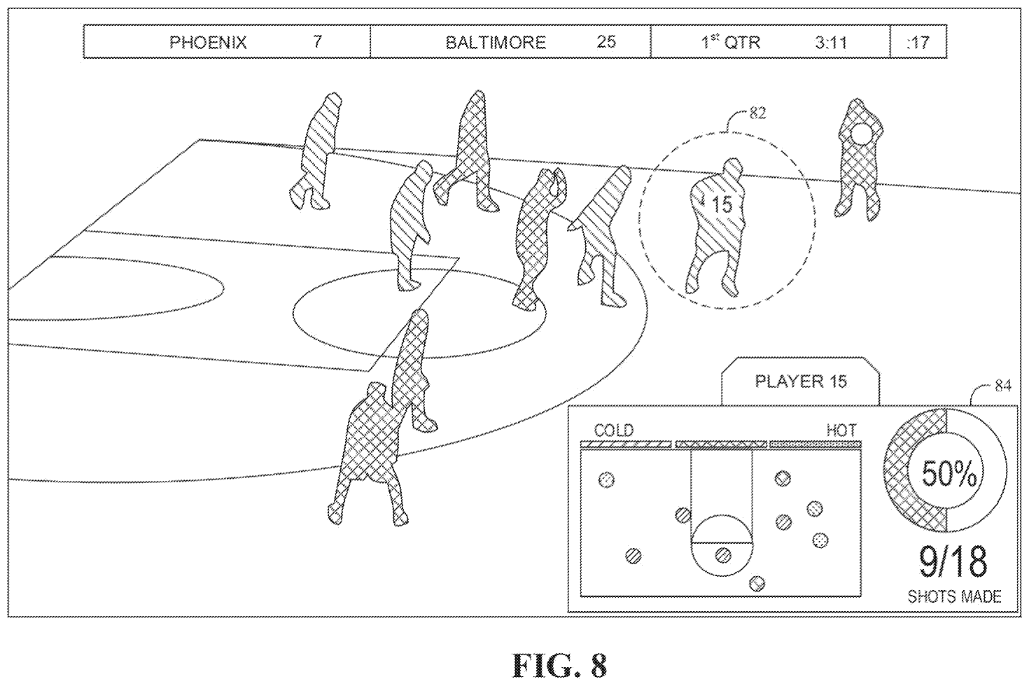

Turning now to FIG. 8, an embodiment of a live video overlay application may be applied to a basketball game. For example, the live video may correspond to a broadcast, satellite, or cable TV signal. In team sports, a wearable sensor may help identify a particular participant. By putting sensors in players' shoes, a ball, and a basket, for example. SHOTTRACKER can track a player's performance on the court, but presents the performance information to the user separate from the game video. FIG. 8 shows one snapshot of a basketball game where some embodiments may improve the user experience by overlaying the latest statistical data for each player on the video in the context of augmented reality and virtual reality. For example, the bounding box 82 around player with jersey number 15 (e.g., autodetected or manually checking his jersey number) may correspond to a player identification (ID). Some embodiments may use this ID to extract the corresponding sensor data. Some embodiments may overlay statistical information 84 on the screen near the player location. The statistical information 84 may follow the player around the screen as the player changes locations on the screen. The position of the displayed information relative to the player may change based on the player's location on the screen and other contextual information such as the location of the basket, the location of other players, etc. What information is displayed and various display location preferences may be user configurable.

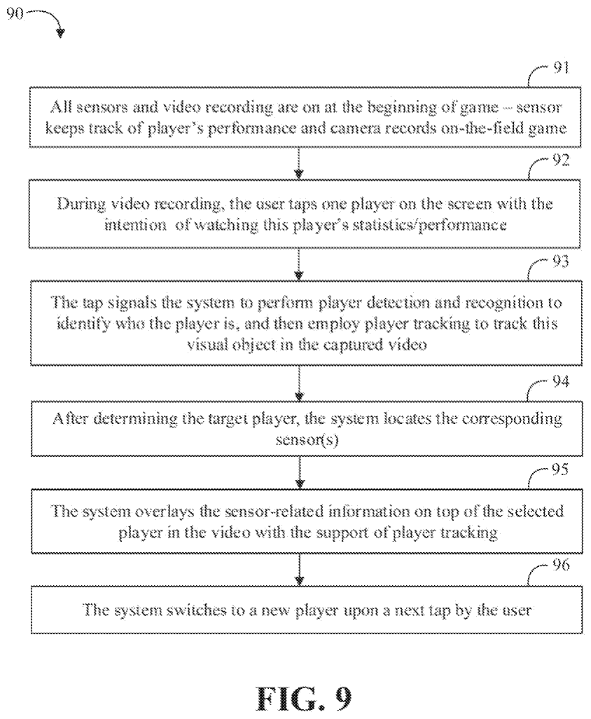

Turning now to FIG. 9, an embodiment of a method 90 of automating the alignment of sensor data with video for multiple players may include turning on sensor and video capture at the beginning of a game, tracking player performance with the sensors, and recording on-the-field game data with a camera at block 91. During the video recording, the method 90 may include the user tapping one player on the screen at block 92 with the intention of watching this player's statistics/performance. To recognize the player that user taps, some embodiments may employ either jersey number, face recognition, or other marker recognition. Upon the tap, the method 90 may include performing player detection and recognition to identify who the player is, and then employing player tracking to track this visual object in the captured video at block 93. To detect and track the player, any useful technology may be used such as fast region-based conventional network (fast-RCN), kernel correlation filter (KCF), etc.

After determining the target player, the method 90 may include locating the corresponding sensor(s) at block 94. Because the sensor(s) are registered to the player before the game, and because the sensor(s) also output location on the field information, the visual object location may be matched to the sensor location to extract the right sensor data. The method 90 may then include overlaying the sensor-related information data near or on top of the selected player in the video with the support of player tracking at block 95. The method 90 may include switching to a new player upon a next tap at block 96.

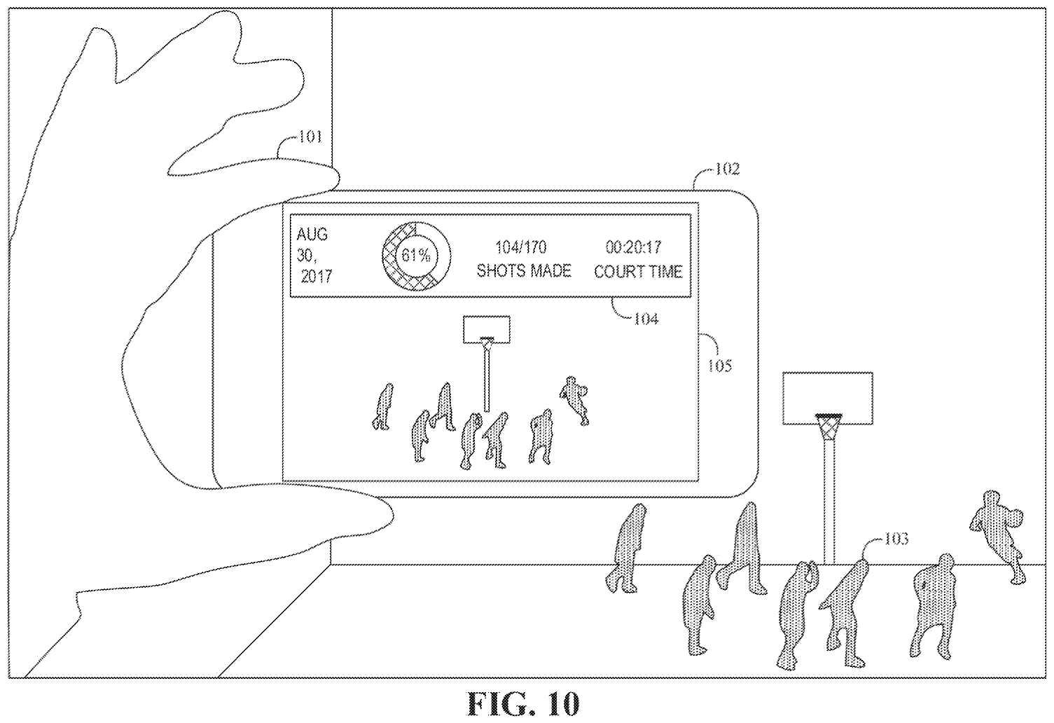

FIG. 10 shows one snapshot of aligning sensor data and overlaying it on top of live video. A user 101 may hold a device 102 such as a tablet or a smartphone which includes a camera. For example, the live video may correspond to video captured by a camera on the device 102. The user 101 may position the device 102 to capture video of a basketball game with several participants 103. One or more of the participants 103, the basketball, and/or the basket may have associated sensors measuring and/or collecting data. An embodiment of a metrics overlay app 104 loaded on the smartphone may overlay metrics on a display screen 105 of the device 102. Advantageously, the app 104 may analyze the video content to align the screen space with the sensor space. For example, the app 104 may determine the location of the basketball on the screen 105 and overlay the metrics information on the screen 105 such that the overlay does not obstruct the view of the basketball. Additionally, or alternatively, the app 104 may allow the user 101 to touch the screen 105 to select a player of interest to the user 101, track the location of the selected player on the screen 105 as they move around the court, identify sensors associated with the selected player, and overlay metrics for the selected player on the screen 105 such that the overlay is near the selected player but does not obstruct the view of the selected player on the screen 105. Given the benefit of the present specification and drawings, numerous other examples of useful features for the app 104 will occur to those skilled in the art.

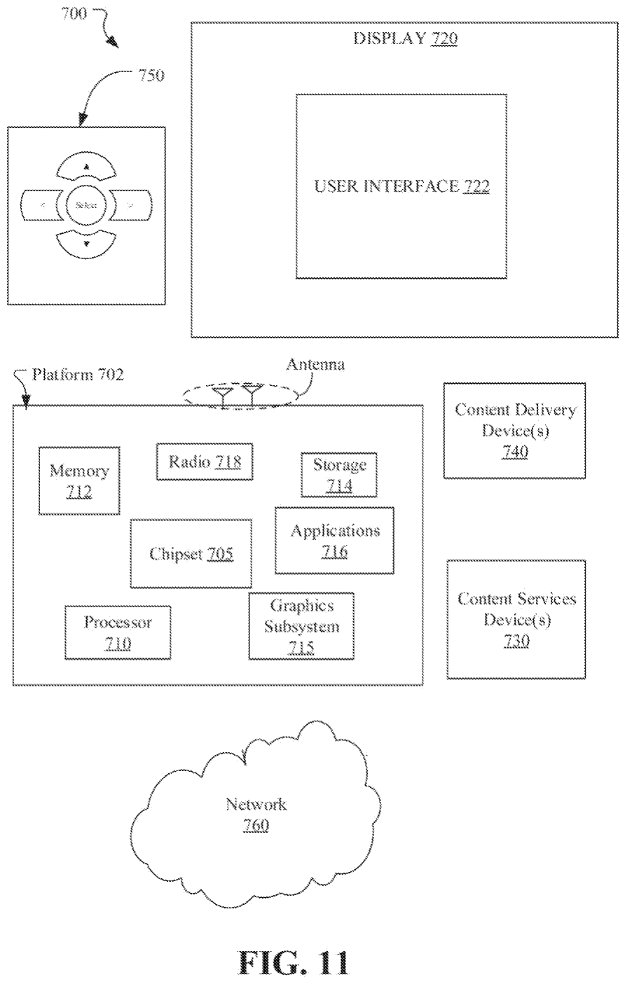

FIG. 11 illustrates an embodiment of a system 700. In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, the system 700 comprises a platform 702 coupled to a display 720 that presents visual content. The platform 702 may receive video bitstream content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In embodiments, the platform 702 may comprise any combination of a chipset 705, processor 710, memory 712, storage 714, graphics subsystem 715, applications 716 and/or radio 718 (e.g., network controller). The chipset 705 may provide intercommunication among the processor 710, memory 712, storage 714, graphics subsystem 715, applications 716 and/or radio 718. For example, the chipset 705 may include a storage adapter (not depicted) capable of providing intercommunication with the storage 714.

The processor 710 may be implemented as Complex Instruction Set Computer (CISC) or Reduced Instruction Set Computer (RISC) processors, x86 instruction set compatible processors, multi-core, or any other microprocessor or central processing unit (CPU). In embodiments, the processor 710 may comprise dual-core processor(s), dual-core mobile processor(s), and so forth.

The memory 712 may be implemented as a volatile memory device such as, but not limited to, a Random Access Memory (RAM), Dynamic Random Access Memory (DRAM), or Static RAM (SRAM).

The storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

The graphics subsystem 715 may perform processing of images such as still or video for display. The graphics subsystem 715 may be a graphics processing unit (GPU) or a visual processing unit (VPU), for example. An analog or digital interface may be used to communicatively couple the graphics subsystem 715 and display 720. For example, the interface may be any of a High-Definition Multimedia Interface (HDMI), DisplayPort, wireless HDMI, and/or wireless HD compliant techniques. The graphics subsystem 715 could be integrated into processor 710 or chipset 705. The graphics subsystem 715 could be a stand-alone card communicatively coupled to the chipset 705. In one example, the graphics subsystem 715 includes a noise reduction subsystem as described herein.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

The radio 718 may be a network controller including one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In embodiments, the display 720 may comprise any television type monitor or display. The display 720 may comprise, for example, a computer display screen, touch screen display, video monitor, television-like device, and/or a television. The display 720 may be digital and/or analog. In embodiments, the display 720 may be a holographic display. Also, the display 720 may be a transparent surface that may receive a visual projection. Such projections may convey various forms of information, images, and/or objects. For example, such projections may be a visual overlay for a mobile augmented reality (MAR) application. Under the control of one or more software applications 716, the platform 702 may display user interface 722 on the display 720.

In embodiments, content services device(s) 730 may be hosted by any national, international and/or independent service and thus accessible to the platform 702 via the Internet, for example. The content services device(s) 730 may be coupled to the platform 702 and/or to the display 720. The platform 702 and/or content services device(s) 730 may be coupled to a network 760 to communicate (e.g., send and/or receive) media information to and from network 760. The content delivery device(s) 740 also may be coupled to the platform 702 and/or to the display 720.

In embodiments, the content services device(s) 730 may comprise a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

The content services device(s) 730 receives content such as cable television programming including media information, digital information, and/or other content. Examples of content providers may include any cable or satellite television or radio or Internet content providers. The provided examples are not meant to limit embodiments.

In embodiments, the platform 702 may receive control signals from a navigation controller 750 having one or more navigation features. The navigation features of the controller 750 may be used to interact with the user interface 722, for example. In embodiments, the navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of the controller 750 may be echoed on a display (e.g., display 720) by movements of a pointer, cursor, focus ring, or other visual indicators displayed on the display. For example, under the control of software applications 716, the navigation features located on the navigation controller 750 may be mapped to virtual navigation features displayed on the user interface 722, for example. In embodiments, the controller 750 may not be a separate component but integrated into the platform 702 and/or the display 720. Embodiments, however, are not limited to the elements or in the context shown or described herein.

In embodiments, drivers (not shown) may comprise technology to enable users to instantly turn on and off the platform 702 like a television with the touch of a button after initial boot-up, when enabled, for example. Program logic may allow the platform 702 to stream content to media adaptors or other content services device(s) 730 or content delivery device(s) 740 when the platform is turned “off.” In addition, chipset 705 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in the system 700 may be integrated. For example, the platform 702 and the content services device(s) 730 may be integrated, or the platform 702 and the content delivery device(s) 740 may be integrated, or the platform 702, the content services device(s) 730, and the content delivery device(s) 740 may be integrated, for example. In various embodiments, the platform 702 and the display 720 may be an integrated unit. The display 720 and content service device(s) 730 may be integrated, or the display 720 and the content delivery device(s) 740 may be integrated, for example. These examples are not meant to limit the embodiments.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

The platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 11.

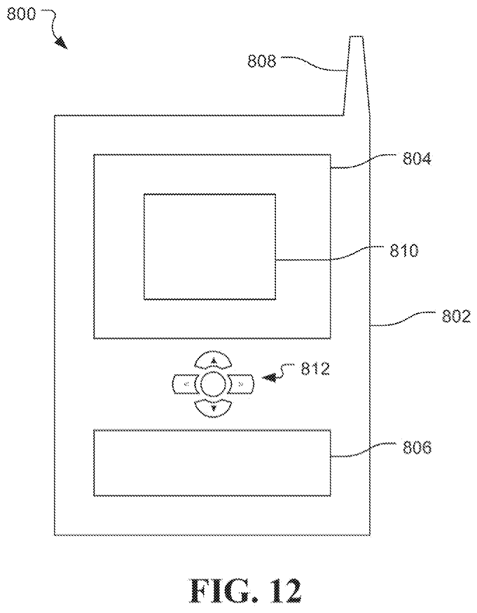

As described above, the system 700 may be embodied in varying physical styles or form factors. FIG. 12 illustrates embodiments of a small form factor device 800 in which the system 700 may be embodied. In embodiments, for example, the device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 12, the device 800 may comprise a housing 802, a display 804, an input/output (I/O) device 806, and an antenna 808. The device 800 also may comprise navigation features 812. The display 804 may comprise any suitable display unit for displaying information appropriate for a mobile computing device. The I/O device 806 may comprise any suitable I/O device for entering information into a mobile computing device. Examples for the I/O device 806 may include an alphanumeric keyboard, a numeric keypad, a touch pad, input keys, buttons, switches, rocker switches, microphones, speakers, voice recognition device and software, and so forth. Information also may be entered into the device 800 by way of microphone. Such information may be digitized by a voice recognition device. The embodiments are not limited in this context.

In accordance with some embodiments, any of the system 700) and the device 800 may be configured with one or more features/aspects of a sensor alignment system described herein. In particular, the system 700 and/or the device 800 may implement one or more aspects of the method 30 (FIGS. 3A to 3C), the method 60 (FIG. 6), and/or the method 90 (FIG. 9), and may include one or more features of the below Additional Notes and Examples.

### ADDITIONAL NOTES AND EXAMPLES

Example 1 may include an electronic processing system, comprising a processor, memory communicatively coupled to the processor, and logic communicatively coupled to the processor to recognize an action in a video, determine a synchronization point in the video based on the recognized action, and align sensor-related information with the video based on the synchronization point.

Example 2 may include the system of Example 1, wherein the logic is further to determine the synchronization point based on computer vision.

Example 3 may include the system of Example 1, wherein the logic is further to recognize a participant in the video, track a location of the participant in the video, and map the sensor-related information to the tracked location of the participant in the video.

Example 4 may include the system of any of Examples 1 to 3, wherein the logic is further to identify two or more participants in the video, associate each participant with a sensor worn by the participant, and overlay sensor-related information corresponding to the associated participant in the video.

Example 5 may include the system of any of Examples 1 to 3, wherein the logic is further to estimate a pose of the participant to recognize a start of an action.

Example 6 may include the system of any of Examples 1 to 3, wherein the logic is further to select a participant to track based on an input from a user.

Example 7 may include a semiconductor package apparatus, comprising a substrate, and logic coupled to the substrate, wherein the logic is at least partly implemented in one or more of configurable logic and fixed-functionality hardware logic, the logic coupled to the substrate to recognize an action in a video, determine a synchronization point in the video based on the recognized action, and align sensor-related information with the video based on the synchronization point.

Example 8 may include the apparatus of Example 7, wherein the logic is further to determine the synchronization point based on computer vision.

Example 9 may include the apparatus of Example 7, wherein the logic is further to recognize a participant in the video, track a location of the participant in the video, and map the sensor-related information to the tracked location of the participant in the video.

Example 10 may include the apparatus of any of Examples 7 to 9, wherein the logic is further to identify two or more participants in the video, associate each participant with a sensor worn by the participant, and overlay sensor-related information corresponding to the associated participant in the video.

Example 11 may include the apparatus of any of Examples 7 to 9, wherein the logic is further to estimate a pose of the participant to recognize a start of an action.

Example 12 may include the apparatus of any of Examples 7 to 9, wherein the logic is further to select a participant to track based on an input from a user.

Example 13 may include a method of aligning sensor-related information, comprising recognizing an action in a video, determining a synchronization point in the video based on the recognized action, and aligning sensor-related information with the video based on the synchronization point.

Example 14 may include the method of Example 13, further comprising determining the synchronization point based on computer vision.

Example 15 may include the method of Example 13, further comprising recognizing a participant in the video, tracking a location of the participant in the video, and mapping the sensor-related information to the tracked location of the participant in the video.

Example 16 may include the method of any of Examples 13 to 15, further comprising identifying two or more participants in the video, associating each participant with a sensor worn by the participant, and overlaying sensor-related information corresponding to the associated participant in the video.

Example 17 may include the method of any of Examples 13 to 15, further comprising estimating a pose of the participant to recognize a start of an action.

Example 18 may include the method of any of Examples 13 to 15, further comprising selecting a participant to track based on an input from a user.

Example 19 may include at least one computer readable medium, comprising a set of instructions, which when executed by a computing device, cause the computing device to recognize an action in a video, determine a synchronization point in the video based on the recognized action, and align sensor-related information with the video based on the synchronization point.

Example 20 may include the at least one computer readable medium of Example 19, comprising a further set of instructions, which when executed by the computing device, cause the computing device to determine the synchronization point based on computer vision.

Example 21 may include the at least one computer readable medium of Example 19, comprising a further set of instructions, which when executed by the computing device, cause the computing device to recognize a participant in the video, track a location of the participant in the video, and map the sensor-related information to the tracked location of the participant in the video.

Example 22 may include the at least one computer readable medium of any of Examples 19 to 21, comprising a further set of instructions, which when executed by the computing device, cause the computing device to identify two or more participants in the video, associate each participant with a sensor worn by the participant, and overlay sensor-related information corresponding to the associated participant in the video.

Example 23 may include the at least one computer readable medium of any of Examples 19 to 21, comprising a further set of instructions, which when executed by the computing device, cause the computing device to estimate a pose of the participant to recognize a start of an action.

Example 24 may include the at least one computer readable medium of any of Examples 19 to 21, comprising a further set of instructions, which when executed by the computing device, cause the computing device to select a participant to track based on an input from a user.

Example 25 may include a sensor alignment apparatus, comprising means for recognizing an action in a video, means for determining a synchronization point in the video based on the recognized action, and means for aligning sensor-related to information with the video based on the synchronization point.

Example 26 may include the apparatus of Example 25, further comprising means for determining the synchronization point based on computer vision.

Example 27 may include the apparatus of Example 25, further comprising means for recognizing a participant in the video, means for tracking a location of the participant in the video, and means for mapping the sensor-related information to the tracked location of the participant in the video.

Example 28 may include the apparatus of any of Examples 25 to 27, further comprising means for identifying two or more participants in the video, means for associating each participant with a sensor worn by the participant, and means for overlaying sensor-related information corresponding to the associated participant in the video.

Example 29 may include the apparatus of any of Examples 25 to 27, further comprising means for estimating a pose of the participant to recognize a start of an action.

Example 30 may include the apparatus of any of Examples 25 to 27, further comprising means for selecting a participant to track based on an input from a user.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs). SSD/NAND controller ASICs. and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrase “one or more of A, B, and C” and the phrase “one or more of A, B, or C” both may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

1-24. (canceled)

25. An electronic processing system, comprising:
a processor;
memory communicatively coupled to the processor; and
logic communicatively coupled to the processor to:
recognize an action in a video,
determine a synchronization point in the video based on the recognized action, and
align sensor-related information with the video based on the synchronization point.

26. The system of claim 25, wherein the logic is further to:
determine the synchronization point based on computer vision.

27. The system of claim 25, wherein the logic is further to:
recognize a participant in the video;
track a location of the participant in the video; and
map the sensor-related information to the tracked location of the participant in the video.

28. The system of claim 25, wherein the logic is further to:
identify two or more participants in the video;
associate each participant with a sensor worn by the participant; and
overlay sensor-related information corresponding to the associated participant in the video.

29. The system of claim 25, wherein the logic is further to:
estimate a pose of the participant to recognize a start of an action.

30. The system of claim 25, wherein the logic is further to:
select a participant to track based on an input from a user.

31. A semiconductor package apparatus, comprising:
a substrate; and
logic coupled to the substrate, wherein the logic is at least partly implemented in one or more of configurable logic and fixed-functionality hardware logic, the logic coupled to the substrate to:
recognize an action in a video,
determine a synchronization point in the video based on the recognized action, and
align sensor-related information with the video based on the synchronization point.

32. The apparatus of claim 31, wherein the logic is further to:
determine the synchronization point based on computer vision.

33. The apparatus of claim 31, wherein the logic is further to:
recognize a participant in the video;
track a location of the participant in the video; and
map the sensor-related information to the tracked location of the participant in the video.

34. The apparatus of claim 31, wherein the logic is further to:
identify two or more participants in the video;
associate each participant with a sensor worn by the participant; and
overlay sensor-related information corresponding to the associated participant in the video.

35. The apparatus of claim 31, wherein the logic is further to:
estimate a pose of the participant to recognize a start of an action.

36. The apparatus of claim 31, wherein the logic is further to:
select a participant to track based on an input from a user.

37. A method of aligning sensor-related information, comprising:
recognizing an action in a video;
determining a synchronization point in the video based on the recognized action; and
aligning sensor-related information with the video based on the synchronization point.

38. The method of claim 37, further comprising:
determining the synchronization point based on computer vision.

39. The method of claim 37, further comprising:
recognizing a participant in the video;
tracking a location of the participant in the video; and
mapping the sensor-related information to the tracked location of the participant in the video.

40. The method of claim 37, further comprising:
identifying two or more participants in the video;
associating each participant with a sensor worn by the participant; and
overlaying sensor-related information corresponding to the associated participant in the video.

41. The method of claim 37, further comprising:
estimating a pose of the participant to recognize a start of an action.

42. The method of claim 37, further comprising:
selecting a participant to track based on an input from a user.

43. At least one computer readable medium, comprising a set of instructions, which when executed by a computing device, cause the computing device to:
recognize an action in a video;
determine a synchronization point in the video based on the recognized action; and
align sensor-related information with the video based on the synchronization point.

44. The at least one computer readable medium of claim 43, comprising a further set of instructions, which when executed by the computing device, cause the computing device to:
determine the synchronization point based on computer vision.

45. The at least one computer readable medium of claim 43, comprising a further set of instructions, which when executed by the computing device, cause the computing device to:
recognize a participant in the video;
track a location of the participant in the video; and
map the sensor-related information to the tracked location of the participant in the video.

46. The at least one computer readable medium of claim 43, comprising a further set of instructions, which when executed by the computing device, cause the computing device to:
identify two or more participants in the video;
associate each participant with a sensor worn by the participant; and
overlay sensor-related information corresponding to the associated participant in the video.

47. The at least one computer readable medium of claim 43, comprising a further set of instructions, which when executed by the computing device, cause the computing device to:
estimate a pose of the participant to recognize a start of an action.

48. The at least one computer readable medium of claim 43, comprising a further set of instructions, which when executed by the computing device, cause the computing device to:
select a participant to track based on an input from a user.
